(19) United States
(12) Patent Application Publication
(10) Pub. No.: US 2011/0142574 A1
(43) Pub. Date: Jun. 16, 2011

(54) METHOD OF TRANSFERRING AN OBJECT INTO A CLEAN ROOM

(75) Inventor: Viktor Schnyder, Raron (CH)

(73) Assignee: Lugaia STS Sterile Transfer Solutions AG, Visp (CH)

(21) Appl. No.: 12/988,113

(22) PCT Filed: May 8, 2009
(86) PCT No.: PCT/IB2009/051912

§ 371 Date: Nov. 11, 2010

(30) Foreign Application Priority Data
Jun. 17, 2008 (CH) 0920/2008

(51) Int. Cl. B01L 1/02; B65B 55/02; B25J 21/00

(52) U.S. Cl. 414/221; 53/425; 414/805

(57) ABSTRACT

A method of transferring at least one object, sterilised and packed into a bag, into a clean room, where the bag is connected with an inner liner connecting the clean room with an outer room and on this is opened at an area open towards the inner liner so that a tube-like connection, closed towards the outer room, is formed between the interior of the bag and the inner liner, through which the at least one object is transferred into the clean room.

The invention relates to a method of transferring into a clean room at least one object that is packed in a bag an sterilised.

The invention also relates to an airlock for a clean room for transferring at least one object packed in a bag through an inlet opening.

A method of the type set out above is known from DE 10 044 117 A1. The aim of the known method is to transfer into a clean room objects, more particularly medical objects, in a sterile state. Here, the objects, for example syringes, are arranged in a container made of plastic, which is open at the top and covered there with a gas-permeable, but germ-proof material. The covering of germ-proof material is sealed onto the container with a sealing seam. The thus sealed container is packed into a bag which in turn is made entirely or partially of the same, or similar material to the cover, and again seals the container in a germ-proof but gas-permeable manner. After placing the objects in the container, sealing of the container and packing the container into the bag, the entity is sterilised in a sterilisation chamber. After removal from the sterilisation chamber the packed objects as well as the complete container are sterile. The same applies to the intermediate space between the bag and the container. The outer packaging by way of the bag prevents recontamination of the container. The thus packed container with the objects is then taken its destination. There, the container is taken out of the bag and passed through an airlock into a sterile clean room.

The principal disadvantage of the known method is that due to the necessary removal of the outer packaging before transferring the container into the clean room, there is a risk of contamination of the surface of the container. A further disadvantage is the relatively costly and time-consuming packaging process.

One of the tasks of the invention is therefore to create a method and/or a device which can guarantee complete prevention of contamination when transferring already sterilised objects from a transporting bag into a clean room.

This objective is achieved without a method of the type set out in the introduction, in that a bag is connected with an inner liner connecting the clean room with the outside room and opened at an area facing the inner liner, so that a tube-like connection, closed to the outside room, is formed between the interior of the bag and the inner liner, through which the at least one object is transferred into the clean room.

As a result of the closed system comprising the inner liner and bag, during the transfer procedure contamination of the object(s) in the bag, for example, replacement parts, production accessories, bottles, closures, containers, syringes, flasks, tools etc. can be prevented. The inner liner is designed in the manner of a hose. It can, for example, be formed from an internally and externally weldable and endless flexible tube which is peelable on its inner side after welding.

In accordance with an advantageous variant of the invention the bag is made of an endless flexible tube which can be welded on its outside and inside, whereby after welding the inside of the endless flexible tube it is peelable, and after filling with the at least one object, the bag is closed by welding and the at least one object is sterilised.

To transfer the at least one object into the clean room, an inlet of the inner liner can be arranged around the outside of the bag in such a way that the lateral edge of the inlet comes to lie above a welding seam closing the bag, whereupon the bag is welded to the inlet, so that between its existing welding seam and the inlet-side edge of the inlet, at least one continuous new second welding seam is produced, which connects the inside of the inlet with the outside of the bag, and, at the same point, the inside of the bag, whereupon the peelable inner side of the bag is loosened and the bag is opened in the direction of the clean room to transfer the at least one object.

An alternative variant of the invention envisages that the bag has an inlet and the inner liner is also formed of an endless flexible tube, which is closed with a welding seam, whereby the inlet is arranged so that the edge of the inlet comes to rest above the welding seam, whereupon the endless flexible tube is welded to the inlet, so that between the existing welding seam and the edge of the inlet at least one continuous new second welding seam is produced, which connects the inside of the inlet with the outside of the endless flexible tube, and, at the same point, the inside of the endless flexible tube, whereupon the peelable inside of the endless flexible tube (1a) is loosened and the bag is peeled open and opened in the direction of the clean room to transfer the at least one object.

A further variant of the invention, which is characterised in that with it contamination of objects to be transferred can be very effectively prevented, envisages that a sterilised sack is welded to the inlet of the inner liner, whereby the sterilised sack has a tube-like transition film, which is not internally, but externally weldable and is connected with its side turned away from the inlet to a sack-like sealing film, the sack base of which is within the transition film, and the sack edge of which is connected, for example, welded, to the side of the transition film turned away from the inlet, whereby for the sealing film a synthetic material is selected which is easily weldeable, and the sack-like sealing film is arranged around the outside of the bag containing the at least one object in such a way that the welding seam closing this bag comes to lie within the sack, whereby the bag containing the at least one object is welded to the sealing film so that between the existing welding seam of the bag containing the at least one object and the free edge of the sealing film at least one new welding seam, preferably a double welding seam, is produced, which connects the inside of the sealing film with the outside of the bag containing the at least one object, and, at the same point, the inside of the bag containing the at least one object, whereby during this welding procedure in the middle of the welding seam, preferably between the double welding seams, a separating seam is applied, so that the part, facing the inner liner, of the bag containing the object, is separated in the form of a token enclosing a material together with the surrounding sealing film, whereupon the peelable inner side of the bag containing the at least one object is loosened at a second welded point, so that the at least one object can be transferred into the clean room.

Alternatively to the above variant of the invention the bag can have an inlet to which a sterilised sack is welded, whereby the sterilised sack has a tube-like transition film, which is not internally, but externally weldable and is connected with its side turned away from the inlet to a sack-like sealing film, the sack base of which lies within the transition film and the sack edge is connected, for example welded, to the side of the transition film turned away from the inlet, whereby for the sealing film a synthetic material is selected which is easily weldable, and the sack-like sealing film is arranged around the outside of the inner liner in such a way that a welding seam closing the inner liner comes to lie within the sack, whereby the inner liner is welded to the sealing film, so that between the already existing welding seam of the inner liner and the free edge of the sealing film at least one continuous new welding seam, preferably a double welding seam, is produced, which connects the inside of the sealing film with the outside of the inner liner and, at the same point, the inside of the inner liner, whereby during this welding procedure in the middle of the welding seam, preferably between the double welding seam, a separating weld is produced, so that the part of the bag facing the inner liner is separated in the form of token enclosing a material along with the sealing film surrounding it, whereupon the peelable inside of the inner liner is loosened at its second welded point, so that the at least one object can be transferred into the clean room after peeling open the bag.

The formation of a separated token can be avoided in that the bag has a sack-shaped receptacle for a welded end section of the inner liner, whereby the receptacle is double-walled and is made of a externally weldable and internally non-weldable synthetic material and the walls of the receptacle delimit two separate sections, one of which is closed towards the bag, and the other area is connected to the interior of the bag, whereby for transferring the bag contents, the section of the end section of the inner liner is arranged in the receptacle in such a way that the welding seam comes to lie within the receptacle, whereupon the receptacle and the section of the inlet located therein are welded, so that between the edge of the receptacle and the existing welding seam of the inner liner a further welding seam is produced, whereby a separating seam is placed, preferable in the middle of the further welding seam, so that after loosening of the separating layer between the inside of the bag and the inner liner a tube-like connection for transferring the at least one object into the clean room is produced, and the separated section of the inner liner is contained in a space formed by the base of the receptacle and an outer side wall of the area closed towards the bag and separated section of an external wall of the area open to towards the bag. After transferring the at least one object into the clean room the tube-like connection between the bag and the inner liner is interrupted by applying a welding seam and the inner liner is separated from the bag. In connection which this it has been proven to be particularly advantageous for the inner liner to be formed of an endless flexible tube arranged axially around the inlet to the clean room.

The above objective can also be achieved with an airlock of the type set out in the introductory section in that the airlock has an inner liner penetrating through the inlet opening and connecting the clean room with an outer room, whereby welding means are provided for connecting the inner liner with the bag.

Particularly good protection against contamination of the clean room can be achieved in that the inner liner is closed toward the outer room before the transfer process. Advantageously the inner liner is designed as a weldable endless flexible tube, which is peelable on the inside after welding, through which slight opening of the inner liner in the direction of the bag after welding can be assured.

A further advantageous variant of the invention envisages that the airlock has a chamber, arranged annularly around an inlet to the clean room, in which the inner liner is stored axially around the inlet opening.

The invention, and further advantages, is explained in more detail below with the aid of non-restrictive examples of embodiment shown in the drawing. Schematically:

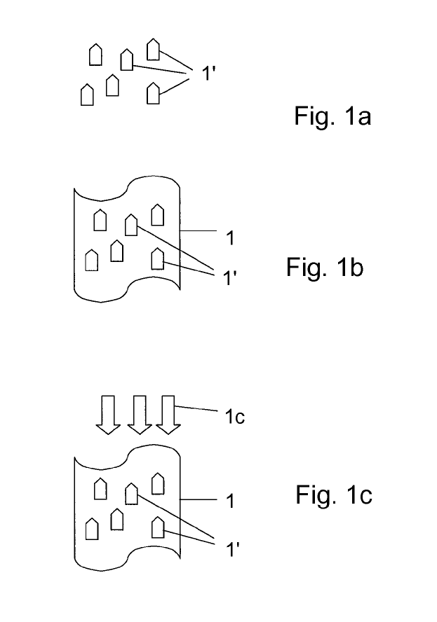

FIGS. 1 a, b, c show the production and sterilisation of objects as well as packaging into bags;

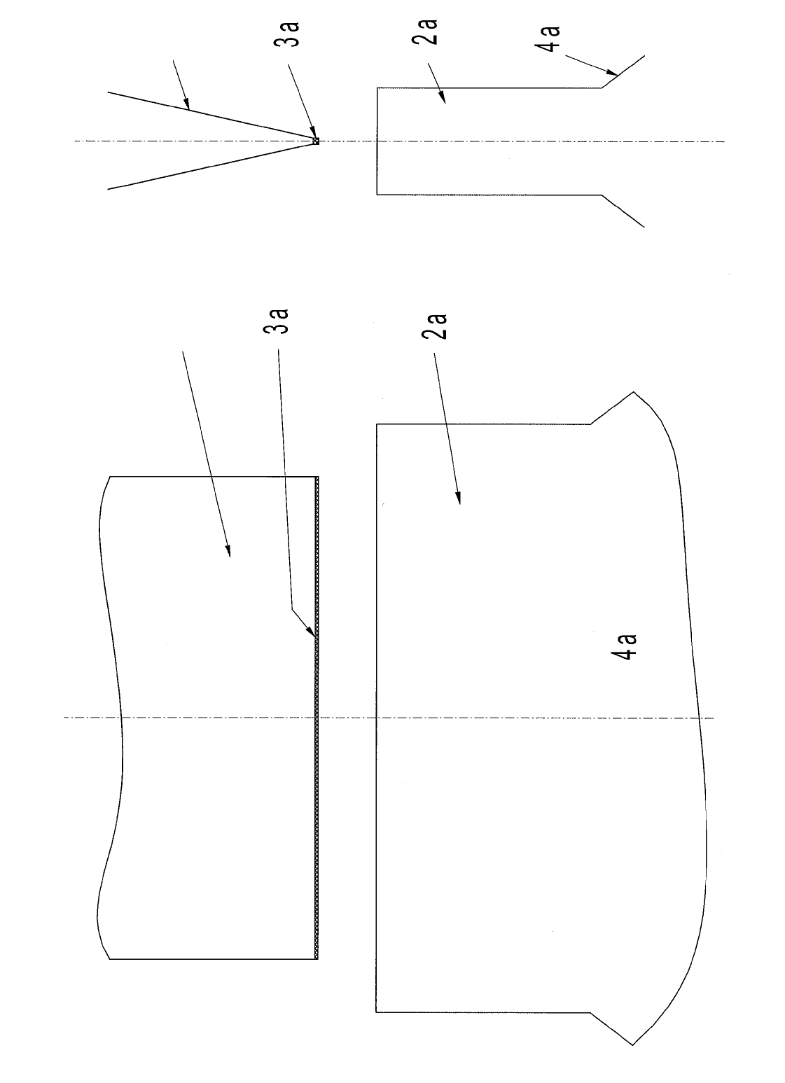

FIG. 2 shows a view of a welded endless flexible tube above the inlet of an inner liner to be filled;

FIG. 3 shows a lateral view of the diagram in FIG. 2;

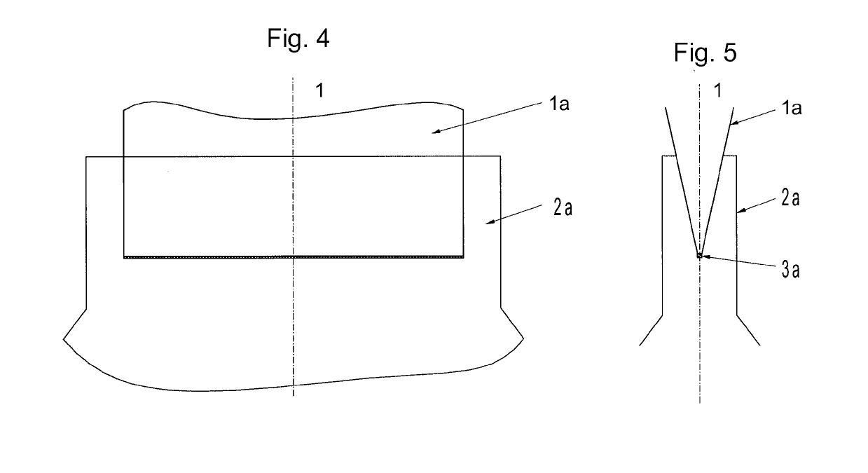

FIG. 4 shows a view of the welded endless flexible tube of FIG. 2 after insertion into the inlet of the inner liner to be filled;

FIG. 5 shows a lateral view of the diagram in FIG. 4;

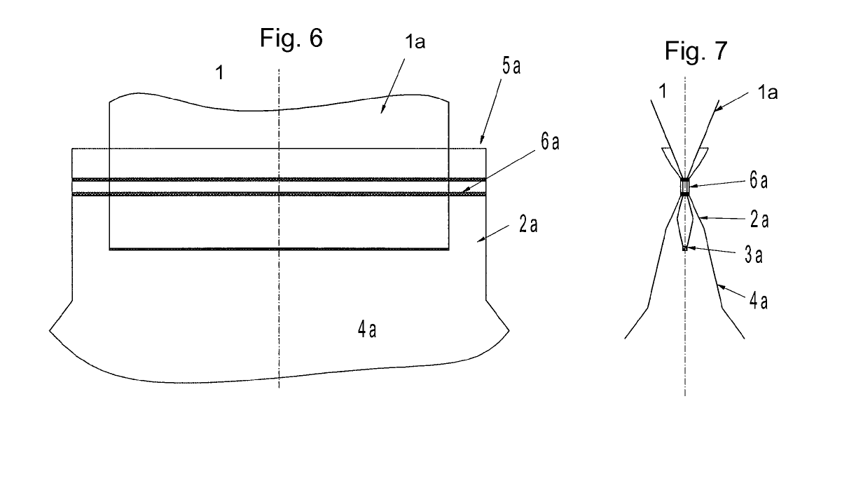

FIG. 6 shows the view in FIG. 4 with an applied welding seam;

FIG. 7 shows a lateral view of the diagram in FIG. 6;

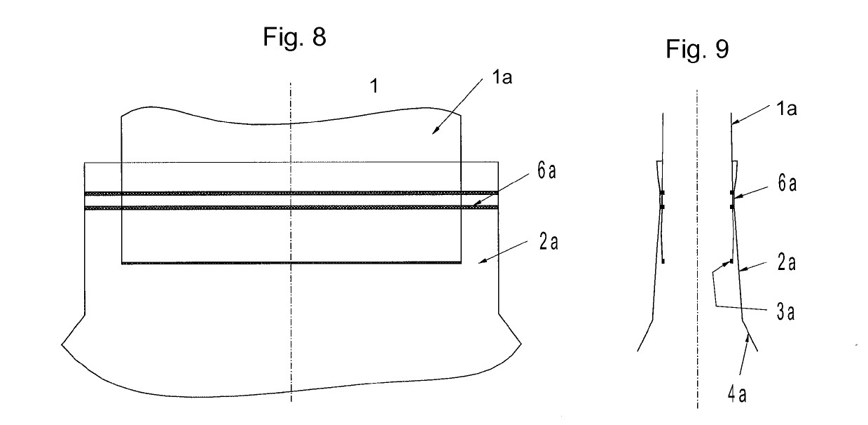

FIG. 8 shows a view of a welded and subsequently peeled endless flexible tube in accordance with FIG. 6;

FIG. 9 shows a lateral view of the diagram in FIG. 8;

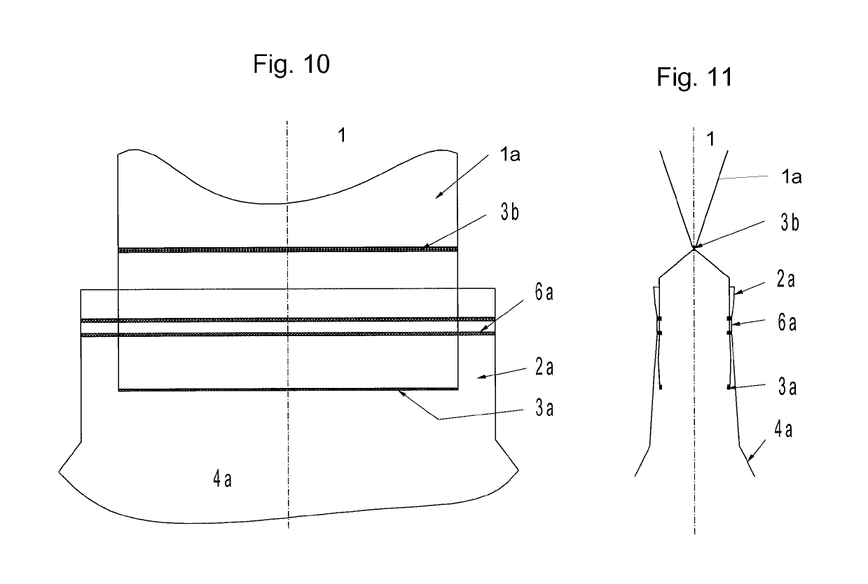

FIG. 10 shows a view of an endless flexible tube in accordance with FIG. 8 peeled and then welded again at a third point;

FIG. 11 shows a side view of the diagram in FIG. 10;

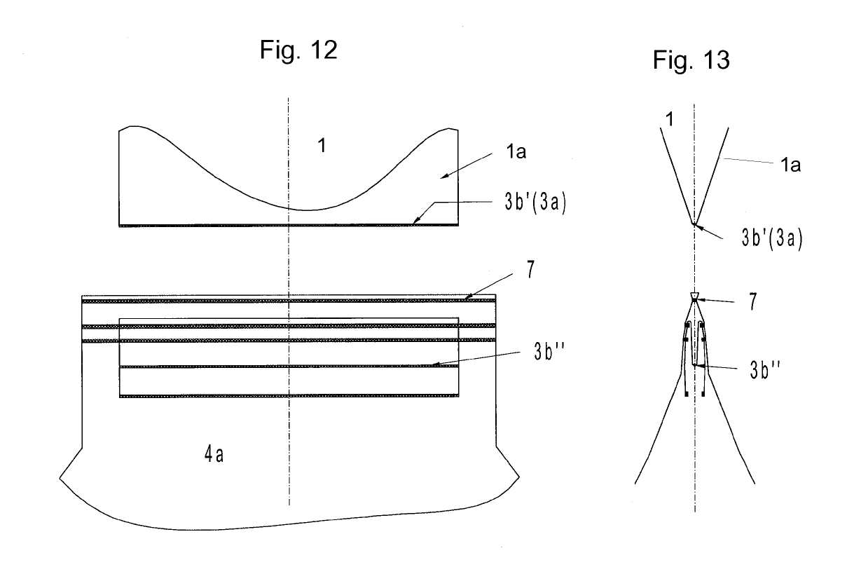

FIG. 12 shows a view of the endless flexible tube, welded again at the third point and separated there, above the inlet in accordance with FIG. 10, whereby the free ends of the inner liner are welded;

FIG. 13 shows a lateral view of the diagram in FIG. 12;

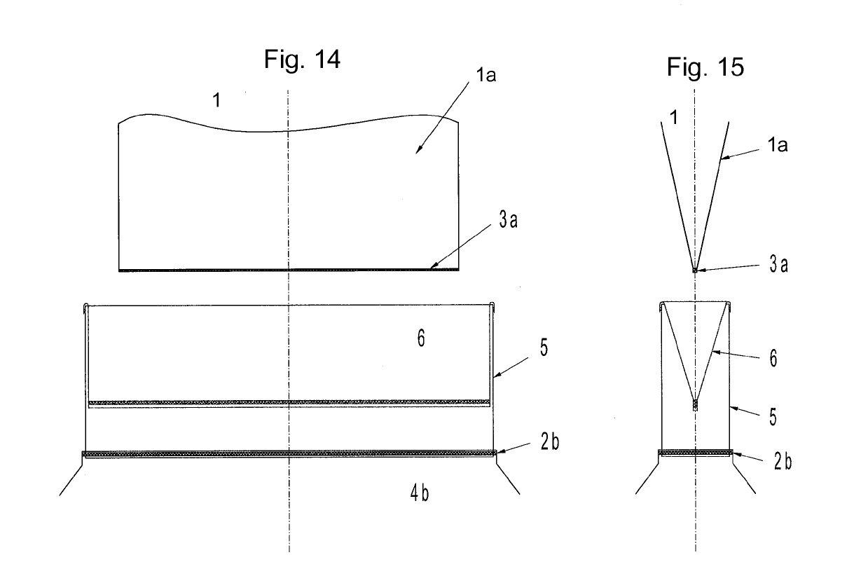

FIG. 14 shows a view of an endless flexible tube in accordance with FIG. 2 above a bag in accordance with the invention at an inlet;

FIG. 15 shows a lateral view of the diagram in accordance with FIG. 14;

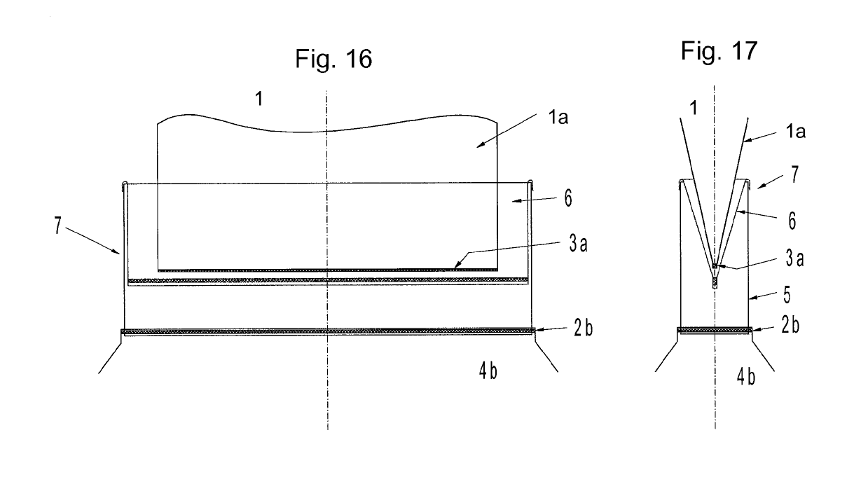

FIG. 16 shows a view of the arrangement in FIG. 14, whereby the endless flexible tube has been inserted into the bag;

FIG. 17 shows a lateral view of the diagram in accordance with FIG. 16;

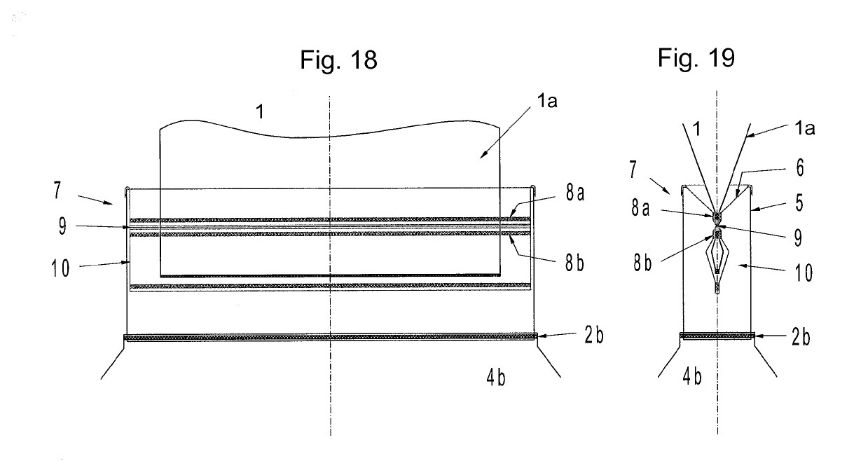

FIG. 18 shows a view of the diagram in FIG. 16 but with an additionally applied welding seam at a second point;

FIG. 19 shows a lateral view of the diagram in accordance with FIG. 18;

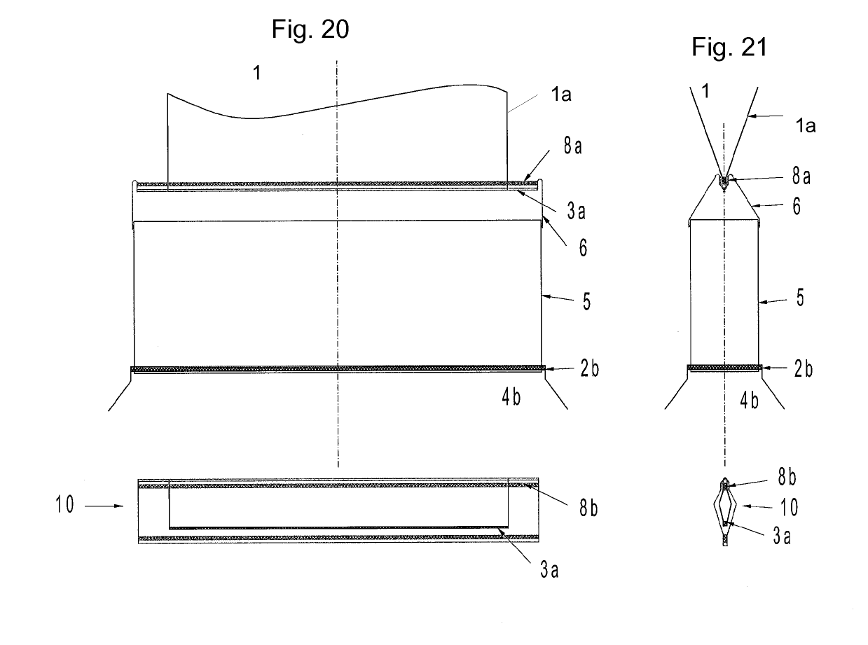

FIG. 20 shows a view of the diagram in accordance with FIG. 18 but with a detached token;

FIG. 21 is a lateral view of the diagram of FIG. 20;

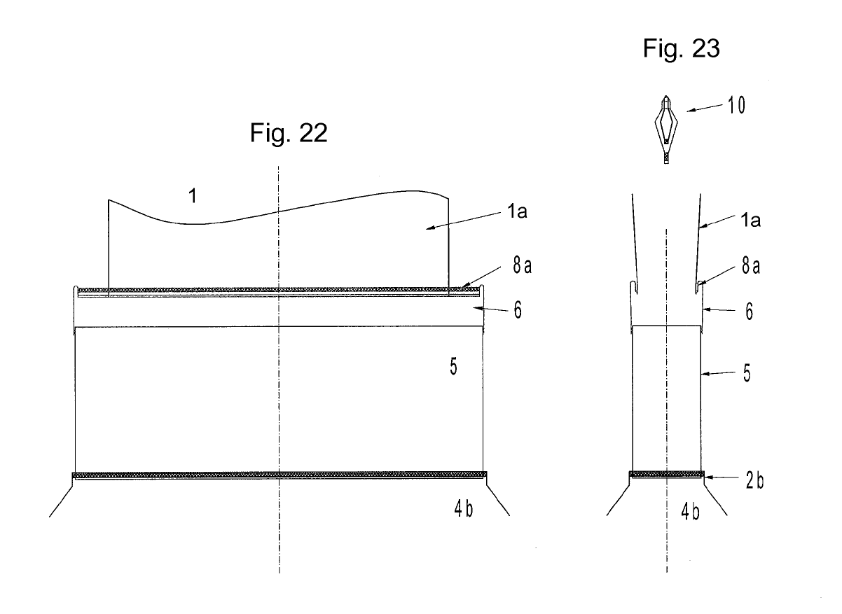

FIG. 22 is a view of the arrangement in accordance with FIG. 20, whereby the endless flexible tube has been peeled (opened) at its first welding point;

FIG. 23 is a side view of the diagram in FIG. 22;

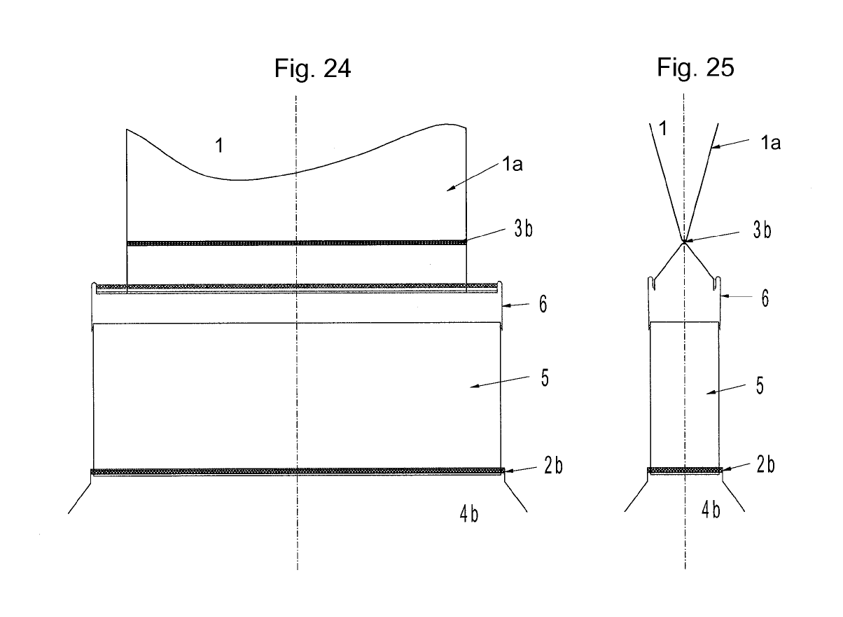

FIGS. 24 and 25 show the arrangement in FIG. 22, after a separating weld has again been applied on the endless flexible tube at a third point;

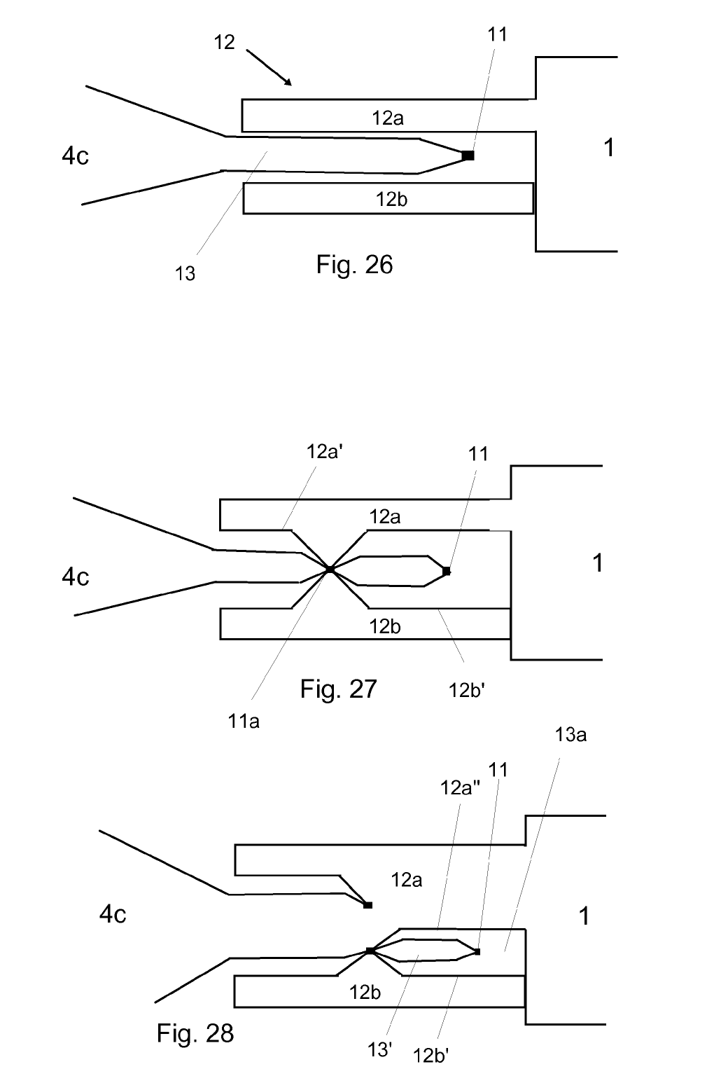

FIG. 26 is a lateral view of a bag with a sack-like receptacle for an end section of an inner liner whereby the end section is inserted into the receptacle;

FIG. 27 shows a lateral view of the arrangement in FIG. 19 whereby the end section of the inner liner is connected to the side walls of the receptacle with a welding seam,

FIG. 28 shows a lateral view of the arrangement in FIG. 26 after separation of the welding seam and after peeling open of the endless flexible tube;

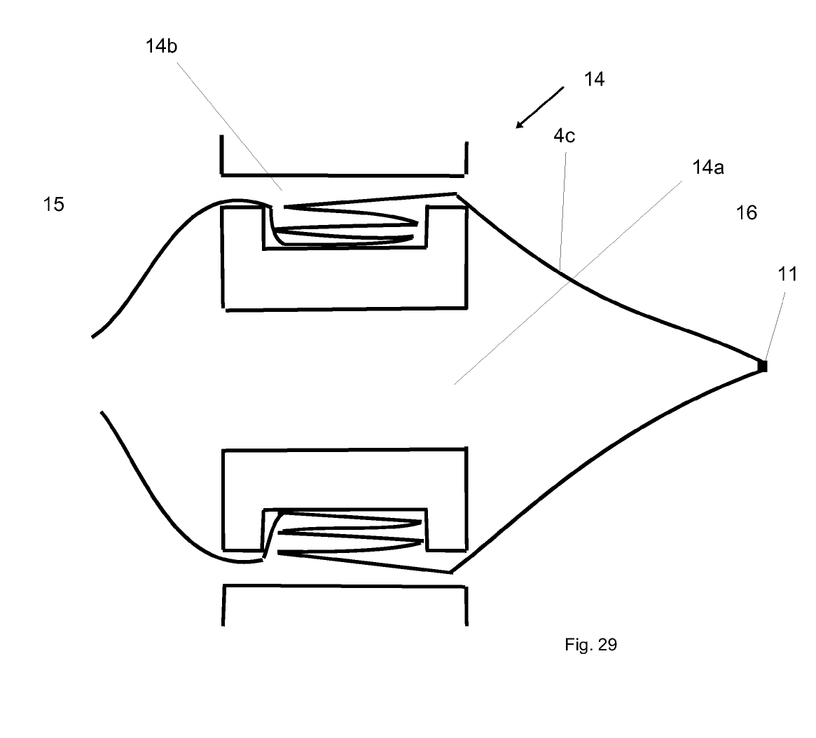

FIG. 29 shows a schematic cross-section through an airlock for a clean room in accordance with the invention.

No longer shown is the detachment of the endless flexible tube after applying the separation weld at the third point of the endless flexible tube. With regard to this reference is made FIGS. 12 and 13, whereby welding of the freely projecting remnants of the inlet can be dispensed with as the detached lower section of the endless flexible tube already serves as a closure for the inner liner and/or inlet.

The figures are described contiguously and in an overall manner. The same components have the same reference number. Similar components or functionally-similar components have the same reference numbers with differing indices.

As shown in FIG. 1a, the objects 1′ to be transferred into a clean room are produced at a location outside the clean room. In FIG. 29 this clean room is given reference number 15.

The objects 1′ are then packed into bags 1 (FIG. 1b) and sterilised at the manufacturer's (FIG. 1c), preferably with gamma radiation, ETO gassing or steam or suchlike 1b. A bag 1 can, depending on the size of the objects 1′ contain one single object 1′ or also a large number of objects 1′, for example in the order of ten of thousands. Bags 1 of plastic are used, which guarantee the sterility of the content during transportation and are also compatible with an inner liner. These sterilised and packed objects 1′ are then transported to a clean room and transferred into it. By way of the invented method, these objects 1′ can be transferred into the clean room in a sterile manner from the bags 1 by means of the inner liner connecting the clean room with the outside room, whereby they reach the clean room from the inside of the bag 1 without further sterilisation on site being required.

In accordance with FIG. 2 the bag 1 is made of an endless flexible tube, which is weldable on its outer side. After welding the inside of the endless flexible tube is peelable and after filling the bag 1 is closed by welding.

FIGS. 2 and 3 also show the initial situation before transferring the objects 1′ into the clean room: according to the invention the bag 1 is connected to an inner liner 4a connecting the clean room with an outside room and is opened at an area facing the inner liner 4a so that a tube-like connection, closed towards the outside room, is formed between the inside of the bag 1 and inner liner 4a, through which the bag can be emptied into the clean room. The inner liner 4a is therefore part of an airlock, or functions as one.

With one free end, which is closed with a closable welding seam 3a, bag 1 faces an inlet 2a. The inlet 2a is part of the inner liner 4a and is internally weldable. In this form of embodiment it is open and therefore not sterile.

FIGS. 4 and 5 show the next stage of transferring the objects 1′, in which the free welded end 3a of the endless flexible tube 1a and/or the bag 1 is placed in the inner liner 4a to be filled and/or its inlet 2a.

FIGS. 6 and 7 show the welding process in accordance with the invention: with a conventional welding device the endless flexible tube 1a and the inlet 2a of the inner liner 4a to be filled are continuously welded to each other (second welding seam 6a). The section 5a projecting above the broad side of the endless flexible tube 1a is also welded through. This results in full protection against contamination as no material can escape between endless flexible tube 1a of the bag 1 and the inlet 2a. Apart from this, a sealed, non-peelable welding seam has been formed between the outside of the endless flexible tube 1a of the bag 1 and the inside of the inlet 2a. The endless flexible tube 1a itself is welded to itself on its inside.

FIGS. 8 and 9 show the process of opening the tube connection to allow the transfer process: the first welding seam 3a and the second welding seam 6a are peeled, i.e. an operator takes the endless flexible tube 1a from outside and pulls it apart, whereby the welding seams 3a and 6a which are inside are peeled open. Opening/peeling can, if required, also be achieved through slight increased inertisation process of the object 1′. The weld between the outside of the endless flexible tube 1a and the inlet 2a remains in place. In this way the inner liner 4a is impermeably connected with the bag 1. In this condition the object 1′ is transferred into the clean room via the inner liner 4a.

FIGS. 10 and 11 show the completion of the filling process. After filling the endless flexible tube 1 is preferably detached with a separating welding seam 3b. A separating welding seam 3b is a welding seam which after the welding process allows the separation of the two components in contact with the welding seam, whereby the two parts remain sealed at the ends facing each other. The transfer process of the object 1′ from the bag 1 into the clean room is therefore enclosed, as the separating weld, as has been mentioned, forms an edge seal. In a new cycle welding seam 3b corresponds to welding seam 3a.

FIGS. 12 and 13 show the next step in which preferably the inner liner 4a is again closed at its upper end, in that the free ends of the inlet 2a are impermeably welded at a fourth point 7. Before this the welded off (3b″) remnant of the endless flexible tube 1 is placed/inserted into the inlet 2a.

In this way a closed transfer process is brought about. The outer side of both the endless flexible tube 1a and bag 1, as well as the inner liner 4a do not come into contact with the objects 1′ to be transferred.

The same feature, but also in addition thereto, the more sterile working conditions, i.e. the fact that during the transfer no substances, germs etc. at all come into contact with the objects to be transferred, is realised by the further developed process described below, according to which the insides of the films never come into contact with the outside environment during the entire transfer process, whereas in the above process the inside only then does not come into contact with the outside environment if they have been in contact with the objects to be transferred.

FIGS. 14 and 15 show the initial situation for the sterile and contamination-free transfer of objects into a clean room in accordance with a further development of the invention:

The inner liner 4b to be filled has a short inlet 2b which is welded to a special tube-like transition film 5. The transition film 3 is not internally weldable, but is externally weldable. On its side facing away from the inlet 2b the transition film 5 is welded to a sack-lie sealing film 6 forming a sealed edge. The sealing film 6 is made of pure PE and can be easily welded on all its sides. The inner liner 4b is impermeably welded to the transition film 5 and can be gas or gamma sterilised. The entire package can thus be supplied as a sterile pack and placed in the device on site (e.g. in the clean room).

FIGS. 16 and 17 shows how the bag 1 is placed with a section in the special inlet structure comprising transition film 5 and sealing film 6 and welded to the inlet shaped as a sack 7: the endless flexible tube 1a and/or the bag 1 is placed in the sack-shaped receptacle of the sealing film 6 of the inner liner 4b to be filled. In this case outer side is taken to mean the side which comes into contact with the outside. However, due to the sack design of the sealing film 6, seen from the sack 7 this is an inner side. However, for linguistic clarification the term outer side is always used in the above sense.

FIGS. 18 and 19 now show the process in which the section of the endless flexible tube 1a of the bag 1 and sealing film 6, inserted into each other, are welded: with a welding device (not shown as it is conventionally known) the endless flexible tube 1a and the sealing film are welded to each other so that two impermeable welding seams 8a, 8b are produced between the endless flexible tube 1a and the bag 7. During this process the endless flexible tube 1 is also welded. During the welding process a separating seam 9 is applied between welding seams 8a and 8b. This separates the non-sterile section in the form of a token 10. The welding and separation are produced from outside through the transition film 5. As the inner layer is not weldable, no connection is formed between the inside of the transition film, 5 and the inside of the sealing film 6 or with the endless flexible tube 1a.

FIGS. 20 and 21 show the process of detaching the token 10, whereby the token falls down into the inner liner 4b and is removed from the clean room side.

FIGS. 22 and 23 show the process of peeling during which the endless flexible tube 1a and with it the sealing film 16 is opened. In contrast the welding between the endless flexible tube 1a and the sealing film 15 remains intact. In this way the inner liner 4b is impermeably connected to the bag 1. In this state the inner liner 4 is filled or emptied in a sterile manner.

At this point it should be pointed out that transfer of the objects 1′ into the clean room can be carried out both as a horizontal as well as a vertical process. Preferably, however, horizontal transfer is carried out as this guarantees better protection against contamination.

The cycle is completed with the stages shown in FIGS. 24 and 25. Separation welding is carried out: after filling, the endless flexible tube 1a can be separated with a separating welding seam 3b. The process in the installation as well as the inner liner 4b is thus completed and sterile as the separating welding seam 3b produces an edge weld.

For a new transfer process separating seal 3b with is edge seal would represent welding seam 3a on the endless flexible tube 1.

FIG. 26-28 show a further variant of the process in accordance with the invention. According to this variant the bag 1 has a sack-like receptacle for an end section 13 of the inner liner 4c closed with a welding seal 11. The receptacle 12 is double-walled and is made of an externally weldable and internally non-weldable synthetic material. The walls of the receptacle delimit two areas 12a, 12b which are separated from each other, of which one is closed towards the bag 1 and the other connected to the inside of the bag 1.

To transfer the contents of the bag the end section 13 of the inner liner 4c is arranged in the receptacle 12 in such a way that the welding seam 11 comes to lie within the receptacle, whereupon the receptacle 12 and the section 1 e of the inner liner 4c located within it are welded, so that between the edge of the receptacle 12 and the already existing welding seam 11 of the inner liner 4c a further welding seam 11 a is produced. A separating weld can be applied to this in order to separate the welding seam 11a. The further welding seam 11a is then separated so that a section 13′ of the inner liner 4c containing the welding seam 11 of the closed end section 13 of the inner liner 4c is detached and contained in a space 13a. The space 13a is formed by the base of the receptacle 12 and an inner side wall 12b′ of the area 12b closed towards the bag 1 as well as a separated side wall section 12a″ of an inner side wall 12a′ of the area 12a open towards the bag (1).

After separation of the welding seam 11a, through the area 12a of the receptacle connected to the inside of the bag 1 and the inner liner 4c, a tube-like connection is formed for transferring the at least one object into the clean room.

Not shown here is that after transferring the at least one object 1′ into the clean room, the tube-like connection between the bag 1 and the inner liner 4c is interrupted through the application of a separating welding seam and the inner liner 4c can be detached from the bag.

FIG. 29 shows an airlock 14 in accordance with the invention for a clean room 15. The airlock 14 has an inlet opening 14a for transferring the object 1′ into the clean room 15. The inlet opening 14a is penetrated by the inner liner 4, which connects the clean room 15 with an outer room 16. Welding means are also envisaged in order to connect the inner liner 4c with the bag 1. The inner liner 4c, formed from an endless flexible tube, is closed all round to the outside room 16 before the filling process. The inner liner 4c is also located axially around the inlet opening 14a in a chamber 14b arranged annularly around the inlet opening 14a of the clean room 15. After each transfer process the inner liner is sealed at its end section lying in an outside room 16 through the application of a welding seam 11 a by means of conventional, and therefore not shown, welding devices located on both sides of an imaginary extension of the axis of the inlet opening 14.

At this point is should be mentioned that all the above processes can also be carried out so that the embodiments of the inner liner 4a, 4b,4c and bag 1 are such that the bag 1 on a connection edge for the inner liner 4a, 4b,4c is designed like the one described above and the inner liner 4a shown in the figures, whereby the inner liner 4a, 4b,4c can be designed at its edge like the bag 1 described above. Essential to the invention is only that the bag 1 and inner liner 4a, 4b, 4c are compatible with each other.

The framework of the invention also includes methods which replace “welding” with “adhesion” insofar as the adhesion exhibits the same properties 14 with regard to peelability as those indicated above for welding. “Welding” should therefore be understood in a very broad sense.

### LIST OF REFERENCE NUMBER

1 Bag contents
1′ Object
1a Endless flexible tube
1b Gamma radiation
2a,b Inlet
3a,b Third welding seam on the endless flexible tube 1
4a,b,c Inner liner of the device into which transfer is to take place.
5 Transition film
6 Sealing film
6a Second welding seam contamination-free embodiment
7 Sack
8a,b Second welding seam sterile embodiment
9 Separating seam
10 Token (waste part)
11 Welding seam on the inner liner 4c
11a Further welding seam
12 Sack-like receptacle
12a Area open towards the bag
12b Area closed towards the bag
12a′ Side wall of the receptacle
12a″ Detached section of the side wall 12a
12b′ Side wall of the receptacle
13 End section of the inner liner 4c
13′ Detached end section
13a Receptacle area for the end section
14 Airlock for a clean room
14a Inlet opening
14b Annular chamber
15 Clean room
16 Outer room

1. A method of transferring at least one object that has been sterilised and packed in a bag into a clean room, where the bag is connected with an inner liner connecting the clean room with an outer room and on this is opened at an area open towards the inner liner so that a tube-like connection, closed towards the outer room is formed between the inside of the bag and the inner liner, through which the at least one object is transferred into the clean room.

2. The method in accordance with claim 1, wherein the bag is made from an endless flexible tube, which is weldable on its inner side and outer side, whereby the inner side of the endless flexible tube is peelable after welding, and the bag, after filling with the at least one object, is closed by welding and the at least one object is then sterilised.

3. The method in accordance with claim 2, wherein to transfer the at least one object into the clean room, an inlet of the inner liner is arranged around the outer side of the bag in such a way that the edge of the inlet on the side facing bag comes to lie above the welding seam sealing the bag, whereupon the bag is welded to the inlet, so that between its already existing welding seam and the edge of inlet on the inlet side at least one continuous new second welding seam is produced, which connects the inner side of the inlet with the outer side of the bag and, at the same point, the inner side of the bag, whereupon the peelable inner side of the bag is loosened and the bag is opened in the direction of the clean room in order to transfer the at least one object.

4. The method in accordance with claim 2, wherein the bag has an inlet and the inner liner is also formed from an endless flexible tube, which is sealed with a welding seam, whereby the inlet is arranged in such a way that the edge of the inlet comes to lie above the welding seam, whereupon the endless flexible tube is welded to the inlet, so that between the existing welding seam and the end of the inlet at least one continuous new second welding seam is produced, which connects the inner side of the inlet with the outer side of the endless flexible tube and, at the same point, the inner side of the endless flexible tube, whereupon the peelable inner side of the endless flexible tube is loosened and the bag peeled open and opened in the direction of the clean room in order to transfer the at least one object.

5. The method in accordance with claim 2, wherein a sterilised sack is welded to the inlet of the inner liner, whereby the sterilised sack has a tube-like transition film which is not internally, but is externally weldable, and is connected with its side facing away from the inlet with a sack-like sealing film, the sack base of which lies within the transition film and the sack edge of which is connected, for example welded, to the side of the transition film facing away from the inlet, whereby for the sealing film a synthetic material is selected which is easily weldable, and is arranged around the outer side of the bag containing the at least one object in such a way that the welding seam sealing this bag comes to lie within the sack, whereby the bag containing the at least on object is welded to the sealing film so that between the already existing welding seam of the bag containing the at least on object and the free edge of the sealing film at least one continuous new welding seam, preferably a double welding is produced, which connects the inner side of the sealing film with the outer side of the bag containing the at least one object, and, at the same point, the inner side of the bag containing the at least one object, whereby during this welding procedure, centrally in the welding seam, preferably between the double welding seams a separating welding seam is applied, so that the section of the bag containing the object which faces the inner liner is detached, along with the sealing film surrounding it, in the form of a token containing a material, whereupon the peelable inner side of the bag containing the at least one object is loosened at a second welded point so that the at least one object can be transferred into the clean room.

6. The method in accordance with claim 2 wherein the bag has an inlet to which a sterilised sack is welded, whereby the sterilised sack has a tube-like transition film, which is not internally weldable but is externally weldable, and is connected with its side facing away from the inlet with a sack-like sealing film, the sack base of which lies within the transition film and the sack edge of which is connected, for example welded, to the side of the transition film facing away from the inlet, whereby for the sealing film a synthetic material is selected which is easily weldable, and is arranged around the outer side of the bag containing the at least one object in such a way that the welding seam comes to lie within the sack, whereby the inner liner is welded to the sealing film so that between the already existing welding seal of the inner liner and the free edge of the sealing film at least one continuous new welding seam, preferably a double welding seam is produced, which, connects the inner side of the sealing film with the outer side of the bag containing the at least one object, and, at the same point, the inner side of the bag containing the at least one object, whereby during this welding procedure, centrally in the welding seam, preferably between the double welding seams a separating welding seam is applied, so that the part of the inner liner facing the bag is, along with the sealing film surrounding it, detached in the form of a token containing a material, whereupon the peelable inner side of the inner liner is loosened at a second welded point, so that the at least one object can be transferred into the clean room after peeling open the bag.

7. The method in accordance with claim 1, wherein the bag has a sack-like receptacle for an end section of the inner liner closed with a welding seam, whereby the receptacle is double-walled and is made of an externally weldable and internally non-weldable synthetic material, and two walls of the receptacle delimit two areas separated from each other, of which one area is closed towards the bag and the other area is connected to the interior of the bag, whereby for transferring the contents of the bag the end section of the inner liner is arranged in the receptacle in such a way that the welding seam comes to lie within the receptacle, whereupon the receptacle and the section of the inner liner located therein are welded, so that between the already existing welding seam of the inner liner a further welding seam is produced, whereupon the further welding seam is separated in such a way that a section of the inner liner containing the welding seam of the closed end section of the inner liner is detached and is contained in a space formed by the base of the receptacle and an inner side wall of the area closed towards the bag and detached side wall section of an inner side wall of the area open towards the bag, whereby a tube-like connection for transferring the at least one object into the clean room is formed by the area of the receptacle in connection with the interior of the bag and by the inner liner.

8. The method in accordance with claim 7, wherein after transferring the at least one object into the clean room the tube-like connection between the bag and the inner liner is interrupted through the application of a welding seam, and the inner liner is detached from the bag.

9. The method in accordance with claim 1, wherein that the inner line is formed from an endless flexible tube axially arranged around an inlet of the clean room.

10. An airlock for a clean room for transferring at least one object packed in a bag through an inlet opening, wherein the airlock has an inner liner penetrating through the inlet opening and connecting the clean room with an outer room, whereby welding means are provided in order to connect the inner liner with the bag.

11. The airlock in accordance with claim 10, wherein the inner liner is closed towards the outer room before the transfer process.

12. The airlock in accordance with claim 10, wherein the inner liner is in the form of an endless flexible tube.

13. The airlock in accordance with claim 10, wherein in that it has a chamber arranged annularly around an inlet opening of the clean room, in which the inner liner is stored coaxially around the inlet opening.

14. A method of transferring at least one object that has been sterilised and packed in a bag into a clean room, wherein the bag is connected with an inner liner connecting the clean room with an outer room and on this is opened at an area open towards the inner liner so that a tube-like connection, closed towards the outer room is formed through which the at least one object is transferred into the clean room, whereby the bag is made of an endless flexible film, which is weldable on its inner side and outer side, whereby the inner side of the endless flexible tube is peelable after welding and the bag, after filling with the at least one object is closed by welding and the at least one object is sterilised.

15. The method in accordance with claim 14, wherein to transfer the at least one object into the clean room a inlet of the inner liner is arranged around the outer side of the bag in such a way that edge of the inlet on the bag side comes to rest above a welding seam closing the bag, whereupon the bag is welded to the inlet so that between its existing welding seam and the edge of the inlet on the inlet side at least one continuous new second welding seam is produced, which connects the inner side of the inlet with the outer side of the bag and, at the same point, the inner side of the bag, whereupon the peelable inner side of the bag is loosened and opened in the direction of the clean room to transfer the at least one object.

16. The method in accordance with claim 14, wherein the bag has an inlet and the inner liner is also formed of an endless flexible tube, which is closed with a welding seam, whereby the inlet is arranged in such a way that the edge of the inlet comes to lie above the welding seam, whereupon the endless flexible tube is welded to the inlet, so that between the already existing welding seam and the edge of the inlet at least one continuous new second welding seam is produced which connects the inner side of the inlet with the outer side of the endless flexible tube and also, at the same point, the inner side of the endless flexible tube, whereupon the peelable inner side of the endless flexible tube is loosened and the bag peeled open and opened in the direction of the clean room for transferring the at least one object.

17. The method in accordance with claim 14, wherein a sterilised sack is welded to an inlet of the inner liner, whereby the sterilised sack has a tube-like transition film, which is internally not weldable but externally weldable, and is connected with its side facing away from the inlet to a sack-like sealing film, the sack base of which lies within the transition film and the sack edge of which is connected, for example welded to the side of the transition film facing away from the inlet, whereby for the sealing film a synthetic material is selected which is easily weldable, and the sack-like sealing film is arranged around the outer side of the bag containing the at least one object in such a way that the sealing weld closing the bag comes to lie within the sack, whereby the bag containing the at least one object is welded to the sealing film so that between the existing welding seam of the bag containing the at least one object and the free edge of the sealing film at least one continuous new welding seam, preferably a double welding seam is produced, which connects the inner side of the sealing film with the outer side of the bag containing the at least one object and, at the same point, the inner side of the bag containing the at least one object, whereby during this welding procedure centrally to the welding seam, preferably between the double welding seams a separating seam is applied, so that the section of the bag containing the object facing the inner liner is detached, along with the sealing film surrounding it, in the form of a token, whereupon the peelable inner side the bag containing the at least one object is loosened at its second welded point so that the at least one object can be transferred into the clean room.

18. The method in accordance with claim 14, wherein the bag has an inlet which is welded to an sterilised sack, whereby the sterilised sack has a tube-like transition film, which is internally not weldable but externally weldable, connected with its side facing away from the inlet to a sack-like sealing film, the sack base of which lies within the transition film and the sack edge of which is connected, for example welded, to the side of the transition film facing away from the inlet, whereby for the sealing film a synthetic material is selected which is easily weldable, and the sack-like sealing film is arranged around the outer side of the inner liner in such a way that the welding seam closing the inner liner comes to lie within the sack, whereby the inner liner is welded to the sealing film so that between the already existing welding seam of the inner liner and the free edge of the sealing film at least one continuous new welding seam, preferably a double welding seam is produced, which connects the inner side of the sealing film with the outer side of the inner liner and, at the same point, the inner side of the inner liner, whereby during this welding procedure centrally to the welding seam, preferably between the double welding seams a separating weld is applied, so that the section of the bag containing the object facing the inner liner is detached, along with the sealing film surrounding it, in the form of a token, whereupon the peelable inner side of the inner liner is loosened at its second welded point, so that the at least one object can after peeling open the bag be transferred into the clean room.

19. A method of transferring at least one object, sterilised and packed into a bag, into a clean room characterised in that the bag is connected with an inner liner connecting the clean room with an outer room and on this is opened at an area open towards the inner liner so that a tube-like connection, closed towards the outer room is formed through which the at least one object is transferred into the clean room, whereby the bag has a sack-like receptacle for an end section of the inner liner closed with a welding seam, whereby the receptacle is double-walled and is made of an externally weldable and internally non-weldable synthetic material, and two walls of the receptacle delimit two areas separated from each other, of which one area is closed towards the bag and the other area is connected to the interior of the bag, whereby for transferring the content of the bag the end section of the inner liner is arranged in the receptacle in such a way that the welding seam comes to lie within the receptacle, whereupon the receptacle and section of the inner liner located therein are welded, so that between the edge of the receptacle and the already existing welding seam of the inner liner a further welding seam is produced, whereupon the further welding seam is separated in such a way that a section of the inner liner containing the welding seam of the closed end section of the inner liner is detached and contained in a space formed by the base of the receptacle and an inner side wall of the area closed towards the bag and by detached side wall section of an inner side wall of the area open towards the bag, whereby the area of the receptacle connected to the interior of the bag and the inner liner form a tube-like connection for transferring the at least one object into the clean room.

20. The method in accordance with claim 19, wherein after transferring the at least one object into the clean room the tube-like connection between the bag and the inner liner is interrupted through the application of a welding seam and the inner liner is detached from the bag.

21. The method in accordance with claim 19, wherein the inner liner is formed from an endless flexible tube axially arranged around an inlet of the clean room.

22. A system, comprising at least one object packed in a bag and an airlock for a clean room for transferring the at least one object packed in a bag through an inlet opening characterised in that the inlet has an inner liner penetrating through the inlet opening and connecting the clean room with an outer room, whereby welding means are provided in order to connect the inner liner with the bag.

23. The system in accordance with claim 22, wherein the inner liner is closed toward the outer room before the transfer procedure.

24. The system in accordance with claim 22, wherein the inner liner is in the form of an endless flexible tube.

25. The system in accordance with claim 24, wherein it has a chamber arranged annularly around an inlet opening of the clean room, in which the inner liner is stored coaxially around the inlet opening.

26. The method in accordance with claim 14, wherein the inner liner is formed from an endless flexible tube axially arranged around an inlet of the clean room.
